(19) United States
(12) Patent Application Publication
(10) Pub. No.: US 2006/0126877 A1
(43) Pub. Date: Jun. 15, 2006

(54) Method for simulating a movement by means of an acoustic reproduction device, and sound reproduction arrangement therefor

(76) Inventor: Christoph Porschmann, Gladbeck (DE)

Correspondence Address: BELL, BOYD & LLOYD, LLC, P. O. BOX 1135, CHICAGO, IL, 60690-1135, US

(21) Appl. No.: 10/531,840

(22) PCT Filed: Oct. 6, 2003
(86) PCT No.: PCT/DE03/03309

§ 371 Date: Dec. 5, 2005

(30) Foreign Application Priority Data
Oct. 18, 2002 (DE) 102 48 754.5

(51) Int. Cl. H04R 1/02; H04R 9/06

(52) U.S. Cl. 381/334

(57) ABSTRACT

A system and method is disclosed for simulating a movement in a predetermined direction relative to a reference point in the surroundings of an acoustic reproduction device, wherein at least two virtual sound sources are produced via the acoustic reproduction device. The acoustic reproduction device is preferably controlled using a control unit, wherein the control unit controls the repeated movement of the at least two virtual sound sources in succession from a predetermined starting point to a predetermined ending point, and back again to the starting point, and controlling a direction of movement for the at least two virtual sound sources such that the direction of movement coincides with the direction of the movement to be simulated.

### TECHNICAL FIELD

The present disclosure relates to a system and method for simulating a movement in a predetermined direction relative to a reference point in the surroundings of an acoustic reproduction device, and to a sound reproduction arrangement for carrying out such a method.

### BACKGROUND

A moving performance from sound sources is known in principle in the prior art. In such cases, a person in the surroundings of the acoustic reproduction device has movement through space simulated by virtue of a sound source produced by the acoustic reproduction device moving relative to the person in a predetermined direction of movement.

An example that illustrates this concept is the movement of a sound source from a first loudspeaker to a second loudspeaker, that is placed at a distance from the first loudspeaker, by means of an acoustic reproduction device.

In the prior art, “virtual sound sources” are typically implemented within the overall system. A virtual sound source is implemented by means of suitable superimposition of sound signals, so that a person hearing these signals is given the impression that the sound signals heard came from a particular point in space in his or her surroundings. Further details of virtual sound sources may be found in the article titled: “An Interactive Virtual-Environment Generator for Psychoacoustic Research, I: Architecture and Implementation” by J. Blauert et al. in ACUSTICA/Acta Acustica” 86, 2000, pp. 94-102. Furthermore, the article titled: “Binaural Room Scanning—A new Tool for Acoustic and Psychoacoustic Research” by P. Mackensen et al., which appeared in the DAGA 1999 conference report (annual conference of the German acoustics society), describes the movement of a virtual sound source. The contents of both articles are hereby incorporated by reference in their entirety.

A method for simulating a movement by means of a virtual sound source has the drawback that this sound source needs to move on a circular path, for example, in order to indicate a movement in a particular direction continuously. If the sound source is moving in a straight line, the sound source will become increasingly distant from the person, which means that at a particular time it is no longer possible to indicate the movement to the person.

### SUMMARY

In light of the above, one object of the present disclosure is based on the object of using an acoustic reproduction device to simulate a movement in a predetermined direction, with a generated sound source to both to simulate a movement, and to remain essentially fixed in space, depending on the application.

This object is achieved by a method for simulating a movement in a predetermined direction relative to a reference point in the surroundings of an acoustic reproduction device, having the following steps:

a) the acoustic reproduction device is provided in order to produce at least two virtual sound sources,

b) the acoustic reproduction device is controlled using a control unit that is designed for the repeated movement of the at least two virtual sound sources in succession from a predetermined starting point to a predetermined ending point, and from there abruptly back to the starting point, where a direction of movement for the at least two virtual sound sources coincides with the direction of the movement which is to be simulated.

The effect of the proposed method is that a person who is at the reference point perceives the at least two virtual sound sources as a single sound source which is essentially at a fixed location but simulates movement from the starting point to the ending point.

Preferably, the control in step b) is executed such that a movement by the at least two virtual sound sources is effected essentially at right angles to a connecting line between the reference point and a point in the center between the starting point and the ending point of the movement by the at least two virtual sound sources. Accordingly, it is possible to ensure particularly clear perception of the movement when the aim is to indicate to the person a particular direction of movement by means of the acoustic reproduction device.

If the method is used to indicate to a person the directions “left” or “right” in relation to the person's head, for example, then the method can be carried out in the described manner, with the at least two virtual sound sources in this case being moved either from right to left, and abruptly back again, or from left to right and abruptly back again by means of the control unit. In this context, the mid-point will be situated between the starting point and the ending point of the movement by the at least two virtual sound sources approximately in the center of the person's field of vision.

Alternatively, however, it is also possible to use the method to simulate movements which are at an angle to the connecting line between the reference point and the mid-point between the starting point and the ending point. If the method is used in combination with a navigation system in a motor vehicle, for example, the path between the starting point and the ending point may correspond to a direction which is prescribed by the navigation system. Depending on the respective current whereabouts of the motor vehicle, the path of movement for the at least two virtual sound sources can be adapted such that the direction of travel which is to be selected for the motor vehicle is always indicated audibly.

In one exemplary embodiment, the control in step b) takes place such that for each virtual sound source there is an increase in the sound intensity from the starting point to the mid-point and a decrease in the sound intensity from the mid-point to the ending point. This measure contributes to giving the person who perceives the acoustic reproduction device the impression that there is only a single, essentially fixed-location sound source. In particular, the sound intensity can increase at a constant rate up to the mid-point and can decrease at the same rate from the mid-point to the ending point.

To simulate a uniform movement, it is preferable for a 30 speed of movement for the at least two virtual sound sources to be constant in step b).

To improve the perception properties of the acoustic reproduction device, there should preferably be at least four virtual sound sources used which are controlled in the manner explained with reference to the aforementioned at least two virtual sound sources.

The aforementioned object is also achieved by a sound reproduction arrangement having an acoustic reproduction apparatus for simulating a movement in a predetermined direction relative to a reference point in the surroundings of an acoustic reproduction device. The sound reproduction arrangement further produces at least two virtual sound sources and includes a control unit that is designed for the repeated movement of the at least two virtual sound sources in succession from a predetermined starting point to a predetermined ending point, and from there abruptly back to the starting point, where a direction of movement for the at least two virtual sound sources coincides with the direction of the movement which is to be simulated.

### BRIEF DESCRIPTION OF THE DRAWINGS

The various objects, advantages and novel features of the present disclosure will be more readily apprehended from the following detailed description when read in conjunction with the enclosed drawing, in which:

FIG. 1 illustrates a time sequence for arrangements comprising a plurality of virtual sound sources in relation to a person in the surroundings of the sound sources to simulate a movement for the person.

### DETAILED DESCRIPTION

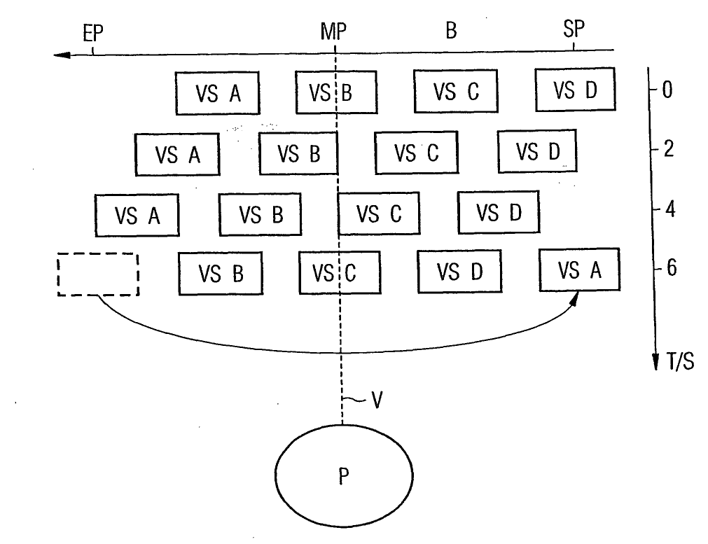

With regard to FIG. 1, it should be noted that the distance shown between virtual sound sources VS A, VS B, VS C and VS D (i.e., four virtual sound sources), and a person, who is represented by an ellipse as a stylized view from above his/her head, need not be comparable with actual distances. In certain instances of application, the distance will be very short, as suggested by the drawing, but it is also possible for the virtual sound sources VS A, VS B VS C and VS D to be at a considerable distance from the person P.

In the exemplary embodiment shown, four virtual sound sources VS A, VS B, VS C and VS D are shown both at a time T=0 s and at further times, where T=2 s, T=4 s and T=6 s. This arrangement illustrates how the relative movement of the individual virtual sound sources VS A, VS B, VS C and VS D relative to the person is executed as a function of time.

At the time T=0 s, the virtual sound sources VS A, VS B, VS C and VS D are in an initial formation, where they are situated on a common line, illustrated in the present exemplary embodiment as a straight line. At the time T=2 s, all of the virtual sound sources have moved one interval to the left at the same speed, this movement continuing up to a time T=4 s.

At the time T=6 s, the leading virtual sound source VS A has been abruptly moved behind the virtual sound source VS D, which means that the virtual sound source VS B is now the leading one and the virtual sound source VS A is now the lagging sound source.

Overall, a movement from right to left in the drawing is thus obtained for all of the virtual sound sources VS A, VS B, VS C and VS D. As soon as the virtual sound source VS B, which is initially arranged behind the virtual sound source VS A, has reached the original position CT=0 s of the virtual sound source VS A in the course of time, the virtual sound source VS A is abruptly moved to the end of the row of virtual sound sources VS A, VS B, VS C, VS D.

The path to be covered by each virtual sound source VS A, VS B, VS C and VS D in order to simulate a movement in the direction of an arrow B in the figure for the person P is identical. This path is defined by a starting point and an ending point. The starting point is defined as a point in space to which each of the virtual sound sources VS A, VS B, VS C, VS D are abruptly returned when they have reached the ending point on the path. When one of the virtual sound sources VS A, VS B, VS C and VS D is abruptly returned to the starting point SP, its sound intensity is preferably 0, which means that no influence is exerted on the acoustic perception by the person P as a result of returning the virtual sound sources VS A, VS B, VS C, VS D. In the case of impaired embodiments, the starting point SP and the ending point EP for the path which is to be covered may also vary.

A mid-point MP on the path covered by the virtual sound sources VS A, VS B, VS C and VS D is situated approximately in the direction of a horizontal mid-axis in the field of vision of the person P. The path covered runs approximately at right angles to a connecting line V between the mid-point on the path and the person P, who defines a reference point.

The movement of the virtual sound sources VS A, VS B, VS C and VS D is controlled by a control unit (not shown) which is connected to an acoustic reproduction device (not shown), which may be headphones or a loudspeaker arrangement, for example.

The acoustic reproduction device and the control unit together form a sound reproduction arrangement that is suitable for carrying out the presently disclosed method. The control unit tracks the position of each of the virtual sound sources VS A, VS B, VS C and VS D at a particular time. Depending on the respective position, the control unit determines the intensity of the sound signal that is emitted by a virtual sound source VS A, VS B, VS C and VS D of interest. From the starting point SP on the right-hand side of FIG. 1, the intensity increases up to the aforementioned mid-point MP, after which it decreases down to the ending point EP. The sound intensity increases and decreases at the same constant rate. This configuration has the advantage that a person P will perceive the sound source arrangement, which is obtained from the four successively arranged virtual sound sources VS A, VS B, VS C and VS D, to be a single sound source which is at a fixed location but which simulates a movement from right to left. In particular, a virtual sound source situated at the left-hand edge is moved abruptly when its intensity has reached its minimum.

Regarding the audio signal to be emitted by the virtual sound sources VS A, VS B, VS C and VS D, it is also possible to use white noise (MLS signal) as a sound signal, for example, as long as the emitted audio signals have a bandwidth that allows the sound signals to be localized. Alternatively, the virtual sound sources VS A, VS B, VS C and VS D may also be voice signals or “auditory icons”, which are naturally or synthetically generated sound signals which have an associated function and which are related to this function by the person P as intuitively as possible. It is preferable that all of the virtual sound sources VS A, VS B, VS C and VS D emit the same audio signal, possibly with changing intensity.

The text below describes a few exemplary alternate embodiments of the above-described method and of the associated sound 35 reproduction arrangement:

### APPLICATION EXAMPLE 1

A person uses a navigation system that is installed in a motor vehicle. When the navigation system uses a voice output to suggest to the person that he turn off to the left after 500 meters, for example, the voice output is played back such that the four virtual sound sources VS A, VS B, VS C and VS D move in the desired direction, in the present case to the left.

### APPLICATION EXAMPLE 2

A person uses a location-related service using a mobile telephone. In this case, he/she uses stereo headphones. The location-related service indicates to the person that he needs to move upward in order to find a department which he is looking for within a shop. In this case, the four virtual sound sources are moved by means of the control unit such that a movement upward is simulated. The audio signal played back in this case, for example “Please move to the next floor up”, then forms the output signal from the virtual sound sources VS A, VS B, VS C and VS D.

From the movement of the virtual sound sources VS A, VS B, VS C and VS D, the person can intuitively tell that he needs to go to the next floor up, for example using an escalator.

### APPLICATION EXAMPLE 3

A mobile telephone may be configured to show user menus virtually in space. In this case, the person using the mobile telephone is visually given the impression that more deeply nested menu entries are further away than the top menu level. The person is thus able to obtain an impression of what is hidden behind a menu item on the top level, for example, and can intuitively move through this virtual spatial representation of menus.

To make navigation in a three-dimensional user menu of this type intuitive, it is possible to use “three-dimensional audio icons”. Using these icons, it is possible to convert a movement by the user into a movement by the virtual sound sources VS A, VS B, VS C and VS D and to render it audible to the user. In this way, he can find his way around better in the three-dimensional virtual spatial representation of the user menus.

### APPLICATION EXAMPLE 4

In the case of a game implemented on a mobile telephone, the aim is to give a person the impression that he/she is moving through a virtual world. In this context, the person's speed of movement needs to change. It is often difficult to clarify the change in the speed of movement solely by means of a visual impression which the person gets from the mobile telephone's display panel, for example.

In this case, parallel performance of the method described above allows the movement to be clarified by virtue of sound effects which are played remaining at a fixed location in space, on the one hand, while the person perceives an apparent movement, on the other. In this way, it is possible to “simulate” the impression of different speeds of movement, for example, for the person.

In this exemplary embodiment, the physical positions of the starting point SP and of the ending point EP over time are not fixed but rather time-dependent. This means that the distance between the virtual sound sources VS A, VS B, VS C, VS D and the person is increased in the present case.

In further application examples, it may also be appropriate for the path covered by the virtual sound sources VS A, VS B, VS C, VS D to be variable over time, but with each of the virtual sound sources VS A, VS B, VS C and VS D continuing to move along the path and to make the abrupt return movement, in particular.

The above description and drawings are only to be considered illustrative of exemplary embodiments, which achieve the features and advantages of the invention. Modification and substitutions to specific process conditions and structures can be made without departing from the spirit and scope of the invention. Accordingly, the invention is not to be considered as being limited by the foregoing description and drawings, but is only limited by the scope of the appended claims.

1-9. (canceled)

10. A method for simulating a movement in a predetermined direction relative to a reference point in the surroundings of an acoustic reproduction device, the method comprising the steps of:
a) producing at least two virtual sound sources via the acoustic reproduction device; and
b) controlling the acoustic reproduction device using a control unit, wherein said control unit controls the repeated movement of the at least two virtual sound sources in succession from a predetermined starting point to a predetermined ending point, and back again to the starting point, and controlling a direction of movement for the at least two virtual sound sources such that the direction of movement coincides with the direction of the movement to be simulated.

11. The method according to claim 10, wherein step b) is performed such that a movement by the at least two virtual sound sources is effected essentially at right angles to a connecting line between a reference point and a point in the center between the starting point and the ending point of the movement by the at least two virtual sound sources.

12. The method according to claim 11, wherein step b) is performed such that, for each virtual sound source, there is an increase in the sound intensity from the starting point to the mid-point, and a decrease in the sound intensity from the mid-point to the ending point.

13. The method according to claim 10, wherein a speed of movement for the at least two virtual sound sources is constant.

14. The method according to claim 10, further comprising:
producing at least two additional virtual sound sources via the acoustic reproduction device, wherein said control unit controls the repeated movement of the at least two additional virtual sound sources in succession from a predetermined starting point to a predetermined ending point, and back again to the starting point, and controlling a direction of movement for the at least two additional virtual sound sources such that the direction of movement coincides with the direction of the movement to be simulated

15. A sound reproduction system, comprising:
an acoustic reproduction apparatus for simulating a movement in a predetermined direction relative to a reference point in the surroundings of an acoustic reproduction device and for producing at least two virtual sound sources; and
a control unit that processes the repeated movement of the at least two virtual sound sources in succession from a predetermined starting point to a predetermined ending point and back again to the starting point, where a direction of movement for the at least two virtual sound sources coincides with the direction of the movement which is to be simulated.

16. The sound reproduction system of claim 15, wherein the control unit has a position detection device for detecting the position of the virtual sound sources and further controls the intensity of each virtual sound source on the basis of its position between the starting point and the ending point.

17. The sound reproduction system of claim 15, wherein the control unit effects a movement by the at least two virtual sound sources substantially at right angles to a connecting line between the reference point and a point in the center between the starting point and the ending point of the movement by the at least two virtual sound sources.

18. The sound reproduction system of claim 15, wherein the control unit effects an increase in the sound intensity from the starting point to the mid-point and a decrease in the sound intensity from the mid-point to the ending point for each virtual sound source.
